(19) United States
(12) Patent Application Publication
(10) Pub. No.: US 2021/0261252 A1
(43) Pub. Date: Aug. 26, 2021

(54) A FLIGHT SYSTEM WITH A PAYLOAD LAUNCHER

(71) Applicant: GAL SOLAR FIELDS LTD, Raanana (IL)

(72) Inventor: Ami DAYAN, Raanana (IL)

(21) Appl. No.: 17/261,020

(22) PCT Filed: Jul. 16, 2019
(86) PCT No.: PCT/IL2019/050798

§ 371 Date: Jan. 17, 2021

Related U.S. Application Data
(60) Provisional application No. 62/698,289, filed on Jul. 16, 2018.

(51) Int. Cl. B64C 39/02; B64C 29/00; B64D 27/24; B64C 3/38; B64D 1/02

(52) U.S. Cl. CPC B64C 39/024; B64C 29/0033; B64D 27/24; B64C 3/38; B64C 2201/128; B64C 2201/027; B64C 2201/042; B64C 2201/108; B64D 1/02

(57) ABSTRACT

There is provided, in accordance with an aspect of some embodiments of the invention, a flight system including an airframe having a longitudinal axis, and a rotor sub-system mounted on the airframe and including a plurality of rotors coupled to at least one secondary axle, the secondary axle configured to: (a) pivot and pitch in respect to the airframe about an axis perpendicular to the longitudinal axis of the airframe, and (b) pivot and roll in respect to the airframe about an axis parallel to the longitudinal axis of the airframe, while maintaining a spatial orientation of the airframe. The flight system may also comprise an airfoil moveable from a passive mode to an active mode.

### RELATED APPLICATIONS

This application claims the benefit of priority of U.S. Provisional Patent Application No. 62/698,289, filed on Jul. 16, 2018. The contents of the above application is incorporated by reference as if fully set forth herein in its entirety.

### FIELD OF THE INVENTION

The present invention, in some embodiments thereof, relates to flight systems and, more particularly, but not exclusively, to unmanned flight systems with launchers.

### BACKGROUND

In recent years remote control and autonomic unmanned flight systems have become prevalent in many fields and for many uses such as e.g., aerial transport, product delivery, aerial photography, agricultural uses, policing, peace keeping, surveillance and military uses.

Commonly, unmanned flight systems are controlled via radio control from a control center on the ground or are autonomous and pre-loaded with information (e.g., navigational information) necessary for autonomous execution of an assignment.

Unmanned flight systems include many configurations from fixed-wing traditional aircraft design, through traditional helicopter design to quadcopter and similar designs.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in accordance with an aspect of some embodiments of the invention, a flight system including an airframe having a longitudinal axis, and a rotor sub-system mounted on the airframe and including a plurality of rotors coupled to at least one secondary axle, the secondary axle configured to: (a) pivot and pitch in respect to the airframe about an axis perpendicular to the longitudinal axis of the airframe, and (b) pivot and roll in respect to the airframe about an axis parallel to the longitudinal axis of the airframe, while maintaining a spatial orientation of the airframe.

According to some embodiments, a pivot of the secondary axle changes a tilt angle of the rotors coupled thereto. In some embodiments, the flight system includes a primary axle pivotly coupled to the airframe and at least one of the secondary axles. In some embodiments, at least one motor is disposed between the secondary axle and the rotor configured to rotate the rotor. In some embodiments, one or more rotor-driving mechanisms disposed between the secondary axle and the rotors. In some embodiments, the rotor sub system is controlled by an on-board processor and/or a remote processor.

In some embodiments, the rotor sub-system includes a fore-secondary axle and an aft-secondary axle and a change in a tilt angle of rotors coupled to the fore-secondary axle in respect to a tilt angle of rotors coupled to the aft-secondary axle effects a change in an attitude of the airframe. In some embodiments, the rotor sub-system is configured to tilt and generate a thrust vector at any desired direction while maintaining spatial orientation of the airframe. In some embodiments, at least two of the rotors on a same secondary axle rotate in opposite directions. In some embodiments, the primary axle is disposed perpendicular to the secondary axles. In some embodiments, the rotor sub-system is an orthogonal rotor tilting system.

There is provided, in accordance with an aspect of some embodiments of the invention, an airframe that includes a longitudinally aerodynamically streamlined geometry. In some embodiments, the flight system includes one or more airfoils mounted on the airframe and configured to generate lift and/or a moment during forward movement of the flight system. In some embodiments, the airfoil is a wing and the airframe includes a wing mount coupled to the wing via a shaft and a wing angle adjusting mechanism.

According to some embodiments of the invention, the wing angle adjusting mechanism includes a clutch configured to move from an engaged state (active mode of operation) to a disengaged state (passive mode of operation).

According to some embodiments of the invention, the flight system includes an active mode of operation and a passive mode of operation. In some embodiments, the active mode of operation the wing angle adjusting mechanism is engaged and controls an angle of the wing in respect to the airframe. In some embodiments, in the passive mode of operation the wing angle adjusting mechanism is disengaged the wing is allowed to pivot freely about the wing shaft in respect to the airframe. In some embodiments, flight of the flight system is based on the lift of the aerodynamics surfaces in which the wing is adjusted to produce the lift and the rotors are tilted forward at an angle configured to supply axial thrust.

In some embodiments, the wing angle adjusting mechanism is controlled by an on-board processor and/or a remote processor. In some embodiments, flight of the flight system is based only on the rotors. In some embodiments, the flight system includes a payload launcher fixedly coupled to the airframe. In some embodiments, a longitudinal axis of the payload launcher is parallel to a longitudinal axis of the airframe. In some embodiments, the payload launcher includes a payload magazine.

In some embodiments, the payload magazine includes a revolving magazine. In some embodiments, the payload launcher is activated pneumatically.

There is provided, in accordance with an aspect of some embodiments of the invention, a flight system including: an airframe having a longitudinal axis, at least one airfoil mounted on the airframe and configured to generate lift and/or a moment during forward movement of the flight system, and n orthogonal rotor sub-system mounted on the airframe and including a plurality of rotors coupled to at least one secondary axle, the secondary axle configured to: (a) pivot and pitch in respect to the airframe about an axis perpendicular to the longitudinal axis of the airframe, and (b) pivot and roll in respect to the airframe about an axis parallel to the longitudinal axis of the airframe, while maintaining a spatial orientation of the airframe.

In some embodiments, a pivot of the secondary axle changes a tilt angle of the rotors coupled thereto. In some embodiments, the flight system rotor sub-system includes a primary axle pivotly coupled to the airframe and at least one of the secondary axles. In some embodiments, the flight system includes a wing mount coupled to a wing via a shaft and a wing angle adjusting mechanism. In some embodiments, the wing angle adjusting mechanism includes a clutch configured to move from an engaged state (active mode of operation) to a disengaged state (passive mode of operation). In some embodiments, the rotor sub-system and/or the wing angle adjusting mechanism are controlled by an on-board processor and/or a remote processor.

There is provided, in accordance with an aspect of some embodiments of the invention, a flight system kit including: an airframe having a longitudinal axis, at least one airfoil mountable on the airframe, and a rotor sub-system mounted on the airframe and including a plurality of rotors coupled to at least one secondary axle, the secondary axle configured to: (a) pivot and pitch in respect to the airframe about an axis perpendicular to the longitudinal axis of the airframe, and (b) pivot and roll in respect to the airframe about an axis parallel to the longitudinal axis of the airframe, while maintaining a spatial orientation of the airframe, at least one rotor driving mechanism, and an on-board processor and/or a remote processor.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIGS. 1A-1B are perspective view simplified illustrations of a flight system comprising a fixed load launching platform in accordance with some embodiments of the invention;

FIG. 2 is a perspective view simplified illustration of a rotor sub-system of a flight system comprising a fixed load launching platform in accordance with some embodiments of the invention;

FIGS. 3A-3E are diagram and perspective view simplified illustrations of the effect of orientation of rotor discs on flight modes of a flight system in accordance with some embodiments of the invention; and

FIGS. 3F-3H are side view simplified illustrations of the wing orientation under an effect of rotor sub-system on an attitude of flight system in accordance with some embodiments of the invention;

FIG. 4 is a perspective view simplified illustration of a wing sub-system of a flight system comprising a fixed payload launcher in accordance with some embodiments of the invention;

FIGS. 5A and 5B are perspective view simplified illustrations of one or more wing positioning and/or configuration associated with varying flight modes in accordance with some embodiments of the invention; and

FIGS. 6A and 6B are an exploded view, a perspective view and a cross section view simplified illustrations of a flight system 100 load launcher 108 in accordance with some embodiment of the invention.

### DETAILED DESCRIPTION

For purposes of better understanding some embodiments of the present invention, as illustrated in the drawings, reference is first made to the construction and operation of a flight system as illustrated in the figures.

According to an aspect of some embodiments of the present invention there is provided a flight system comprising a fixed load launcher. In some embodiments, the fixed load launcher is rigidly coupled to an airframe of the flight system. In some embodiments, the fixed load launcher is hingedly coupled the airframe of the flight system. In some embodiments the flight system comprises an unmanned flight system. In some embodiments, the unmanned flight system comprises one or more rotors. In some embodiments, the rotors are tiltable. In some embodiments, the flight system comprises an orthogonal rotor tilting system.

In some embodiments, the system comprises one or more sources of energy. In some embodiments, the system comprises one or more rotor driving mechanisms. In some embodiments, the system comprises a processor. In some embodiments, the processor controlled one or more of the source of energy, the load launching platform and the rotor-driving mechanism. In some embodiments, the system comprises one or more means of communication. In some embodiments, one or more of the source of energy, the load launching platform and the rotor-driving mechanism are controlled by an on board processor and/or a remote processor via the one or more means of communication.

According to an aspect of some embodiments of the present invention there is provided a flight system comprising one or more rotors and a wing. In some embodiments, the flight system comprises a fixed load launching platform. In some embodiments, the rotors are tiltable. In some embodiments, the flight system comprises an orthogonal rotor tilting system. In some embodiments, the wing comprises one or more modes of operation. In some embodiments, the modes of operation comprise an active mode of operation and a passive mode of operation. In some embodiments, the wing mode of operation is associated with the tilt position of one or more of the rotors. In some embodiments, in the active mode of operation, the angle of the wing actively changes in respect to the longitudinal axis of the system. In some embodiments, the wing is in passive mode of operation in a hovering configuration. In some embodiments, the wing is in passive mode of operation in a forward flying configuration. In some embodiments, the wing is in active mode of operation is effect in a forward flying configuration.

According to an aspect of some embodiments of the present invention there is provided a flight system comprising one or more rotors and a wing. In some embodiments, the rotors are tiltable. In some embodiments, the flight system comprises an orthogonal rotor tilting system. In some embodiments, the wing comprises one or more modes of operation. In some embodiments, the modes of operation comprise an active mode of operation and a passive mode of operation. In some embodiments, the flight system comprises a fixed load launching platform.

In some embodiments, the load launching platform is integrally embedded in the mainframe of the flight system. In some embodiments, the load launching platform is gimballess. In some embodiments, the load launching platform launches a payload. In some embodiments, the trajectory of the payload depends, at least in part, on the spatial orientation of the airframe of the flight system. In some embodiments, the load launching platform comprises one or more launching tubes. In some embodiments, the magazine is integral to the flight system. In some embodiments, the magazine is detachable from the flight system. In some embodiments, the magazine is a box magazine. In some embodiments, the magazine is a rotatable barrel magazine.

In some embodiments, the launching tubes are arranged in a rotatable barrel. In some embodiments, throughout operation, the longitudinal axis of the launching tube remains constant in respect to the longitudinal axis of the flight system. In some embodiments, throughout operation, the longitudinal axis of the launching tube remains parallel to the longitudinal axis of the flight system.

### General

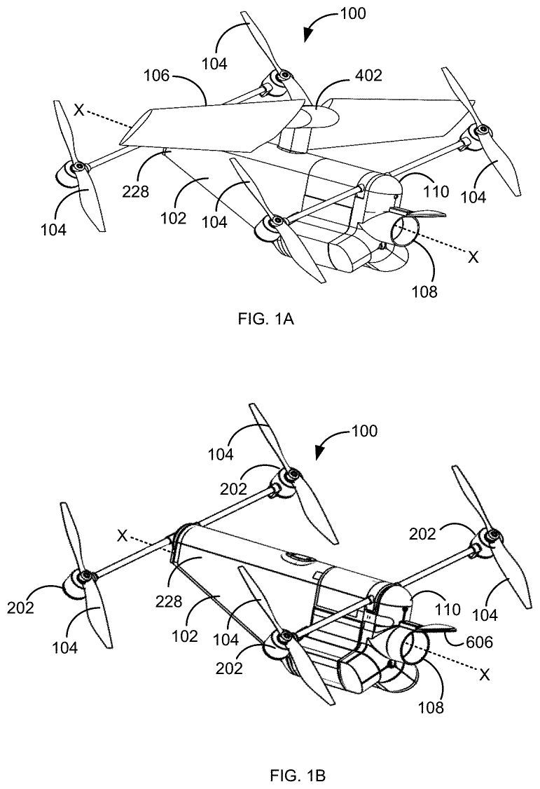

Reference is now made to FIGS. 1A and 1B, collectively referred to as FIG. 1, which are perspective view simplified illustrations of a flight system comprising a fixed load launching platform in accordance with some embodiments of the invention. Flight system 100 provides independent control of both the orientation and velocity vectors and efficient flying characteristics in various flying profiles such as cruising, hovering, acceleration, repositioning/orienting, and aiming. This is done by using controllable multi rotors and one or more wings that adapt themselves to the required flying profile. This flying system can be used for example with a payload such as, for example, a reloadable fixed launcher the orientation of which is determined and controlled by the orientation of the flying system airframe. In some embodiments, the fixed payload launcher 108 is rigidly coupled to the airframe 102 of the flight system 100. In some embodiments, the fixed payload launcher 108 is hingedly or pivotly coupled to the airframe 102 of the flight system 100. In some embodiments, said hingedly or pivotly coupling of payload launcher 108 to airframe 102 is controlled. In some embodiments, said hingedly or pivotly coupling of payload launcher 108 to airframe 102 is uncontrolled. In some embodiments, an as depicted in FIG. 1A, a flight system 100 comprises an airframe 102, one or more rotors 104, a wing 106, and a payload launcher 108. In some embodiments and as shown in FIG. 1, payload launcher 108 is fixedly coupled to, and forms an integral part of flight system 100 airframe 102. In the exemplary embodiment shown in FIG. 1 payload launcher 108 is fixedly coupled to a nose 110 (front portion) of flight system 100 airframe 102. However, in some embodiments, payload launcher 108 may be coupled to flight system 100 airframe 102 at any suitable location. In some embodiments, payload launcher 108 is fixedly coupled to airframe 102 such that a longitudinal axis of payload launcher 108 is in parallel to longitudinal axis (X) of airframe 102. In some embodiments, payload launcher 108 is fixedly coupled to airframe 102 such that a longitudinal axis of payload launcher 108 is at an angle in respect to longitudinal axis (X) of airframe 102.

In some embodiments, wing 106 is detachable from airframe 102. A potential advantage in a detachable wing is in that wing 106 can be removed in missions that do not require wing 106, as explained in greater detail elsewhere herein. FIG. 1B illustrates a wingless flight configuration of flight system 100 with wing 106 removed. Wing 106 comprises a passive mode in which the wing angle in respect to airframe 102 varies passively in reaction to airflow over the surfaces of the wing. With creating minimal or negligible force and/or moments (e.g., lift, drag). In some embodiments, wing 106 comprises an active mode in which wing 106 is temporarily fixed at an angle in respect to a longitudinal axis (X) of flight system 100 to provide lift. As is explained in greater detail elsewhere herein, the one or more rotors 104 are tiltable in one or more directions from a hovering mode to a flight mode.

### The Rotor Sub-System

The rotor system supplies the thrust to drive flight system 100 while functioning as an aerodynamic frame or e.g., as a quadcopter. The rotor sub-system can tilt simultaneously about the pitch and/or yaw axes and generate a thrust vector at any desired direction while maintaining spatial orientation of the airframe. A potential advantage in a dual tilt rotor sub-system is in that the spatial orientation of the flight system airframe, and thus the direction of aim of the launcher, is dissociated from and independent of the velocity vector of the flight system.

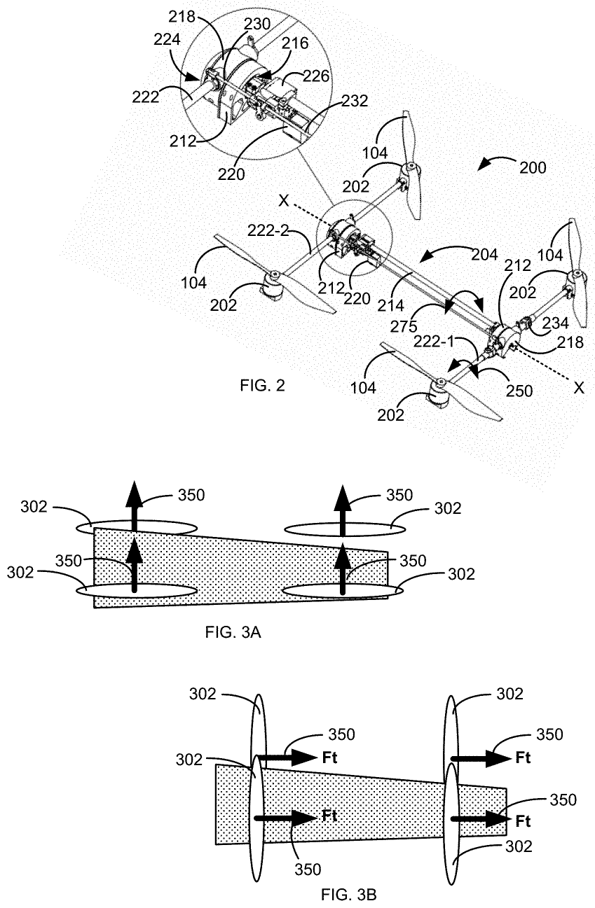

Referring now to FIG. 2, which is a perspective view simplified illustration of a rotor sub-system of a flight system comprising a fixed load launching platform in accordance with some embodiments of the invention. In some embodiments, and as shown in FIG. 2, a flight system 100 comprises a rotor sub-system 200 comprising one or more rotors 104. In some embodiments, rotor sub-system 200 rotors 104 are arranged in pairs. In the exemplary embodiment depicted in FIG. 2, rotor sub-system 200 comprises two pair of rotors, each having a dedicated rotor-driving mechanism (e.g., a motor) 202 and interconnected via an integrated rotor disc tilting mechanism 204. The term “rotor disc” as used herein means the plane circular area swept through by the blades of the rotor.

In some embodiments, dedicated rotor-driving mechanisms 202 are individually controlled by an on-board and/or remote processor such that the amount of thrust concurrently generated by each of rotors 104 may vary from rotor to rotor.

In the exemplary embodiments described herein, rotor sub-system 200 functions as a quadcopter system. However, rotor sub-system 200 is not limited to four rotors and is operative on any plurality of rotor pairs. In some embodiments, rotor disc tilting mechanism 204 is configured to tilt simultaneously on both the pitch and roll axes as indicated in FIG. 2 by corresponding double-headed arrows 250 and 275. In the exemplary embodiment depicted in FIG. 2, flight system 100 is in a state of hovering in which rotors 104 discs are perpendicular to the force vector of gravity exerting lift. Tilting rotor 104 discs forward directs rotor 104 thrust vector forward driving flight system 100 forward. A potential advantage of rotor sub-system 200 is in that rotors 104 can be pitched and rolled at any desired direction to balance lift and thrust vectors while maintaining airframe 102 and thus payload launcher 108, stabilized at any spatial orientation.

In some embodiments, rotor sub-system 200 comprises one or more mounts 212 that couple rotor sub-system 200 to airframe 102. In some embodiments, mounts 212 are disposed along longitudinal axis (X) of flight system 100. Rotor sub-system 200 comprises a primary axle 214 situated along the longitudinal axis (X) of flight system 100 and pivotly coupled at either end to a mount 212. In some embodiments, one or more ends of primary axle 214 is pivotly threaded through a mount passageway 216 in mount 212, e.g., via a ball bearing, and coupled to an end cup 218. In some embodiments, end cup 218 is rotationally coupled to mount 212 e.g., via a ball bearing. In some embodiments, bidirectional rotation (indicated in FIG. 2 by double-headed arrow 275) of primary axle 214 is driven by a roll-servomotor 220. In some embodiments, roll-servomotor 220 is controlled by an on-board and/or a remote processor via various means of communication. Rotation of primary axle 214 may be continuous or stepped.

In some embodiments, rotor sub-system 200 comprises one or more secondary axles 222, e.g., fore and aft axles 222: 222-1 and 222-2 respectively, generally perpendicular to primary axle 214. Secondary axles 222 are pivotable about a plurality of axes at least one being perpendicular to a longitudinal axis (X) of airframe 102 (pitch movement of axle 222 and rotors 104) and a second being parallel to longitudinal axis (X) of airframe 102 (roll movement of axle 222 and rotors 104. In some embodiments, secondary axles 222 comprise at least one dedicated rotor-driving mechanisms 202 at one or more axle ends. In some embodiments, rotor-driving mechanisms 202 are individually controlled by an on-board and/or remote processor such that the amount of thrust concurrently generated by each of rotors 104 may vary from rotor to rotor. Rotor-driving mechanisms 202 at opposite ends of the same secondary axle 222 rotate in opposite directions so that to cancel out the gyroscopic as well as yaw effect effected by the rotating rotors 104.

In some embodiments, one or more secondary axles 222 are pivotly threaded through a cup passageway 224 in cup 218 e.g., via a ball bearing. In some embodiments, bidirectional rotation (indicated in FIG. 2 by double-headed arrow 250) of one or more secondary axles 222 is driven by a pitch-servomotor 226. In some embodiments, pitch-servomotor 226 is controlled by an on-board and/or a remote processor via various means of communication. Rotation of secondary axle 222 may be continuous or stepped.

In some embodiments, only one secondary axle 222 (e.g., axle 222 located at the tail 228 of airframe 102) is driven by pitch-servomotor 226 via a pitch-control rod 230 hingedly coupling a aft-axle 222-2 and pitch-servomotor 226. In some embodiments, and optionally, rotor sub-system 200 comprises a pitch-control extension rod 232 hingedly coupling a fore-axle 222-1 to pitch-servomotor 226 such that two or more secondary axles 222 can be rotated simultaneously by a common actuator e.g., pitch-servomotor 226.

A potential advantage of rotor sub-system 200 axle formation, is in that rotation of one or more primary axles 214 and secondary axles 222 separately or concurrently will effect directional movement of flight system 100 while maintaining flight system 100 airframe 102 (and thus payload launcher 108) spatial orientation. For example, rotation of one or more secondary axles 222 will direct thrust vectors effected by the rotors 104 towards nose 110, in parallel to longitudinal axis (X), effecting forward movement of flight system 100, while rotation of one or more primary axles 214 will direct thrust vectors effected by the rotors 104 sideways, in perpendicular to longitudinal axis (X), effecting sideways movement of flight system 100, however, the spatial orientation of airframe 102 is maintained unchanged.

A potential advantage of rotor sub-system 200 axle formation, is in that rotation of one or more primary axles 214 and secondary axles 222 separately or concurrently will effect speed of movement of flight system 100 while maintaining flight system 100 airframe 102 (and thus payload launcher 108) spatial orientation.

Alternatively, and optionally, in some embodiments, primary axle 214 can be eliminated and secondary axles 222 provided with dedicated rotary actuators (one at each end of flight system 100 airframe 102.

Optionally, in some embodiments, secondary axles 222 may be jointed axles, comprising a reversible locking joint 234. A potential advantage of jointed axles is in that secondary axles 222 are foldable and stackable for convenient storage and shipping.

Optionally, in some embodiments, primary axles 214 and/or secondary axles 222 are hollow. A potential advantage in hollow axles is in that wiring (electric and/or data) can be threaded through the lumen of axles 214/222 eliminating weight of carrier wiring means and keeping loose and resilient wiring away from moving parts e.g., rotors and servo-driven rods thus increasing safety by reducing chances of malfunction and breakdown.

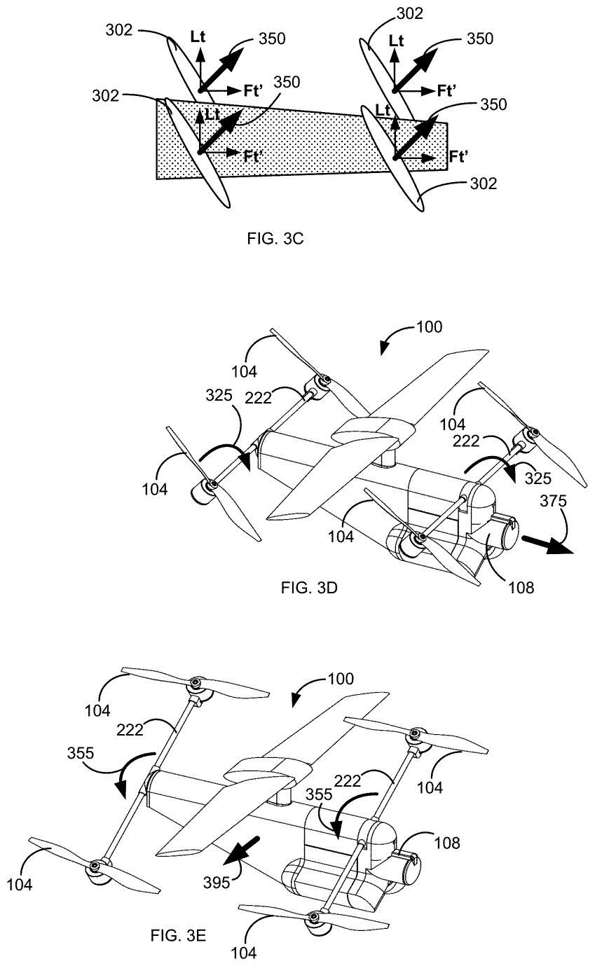

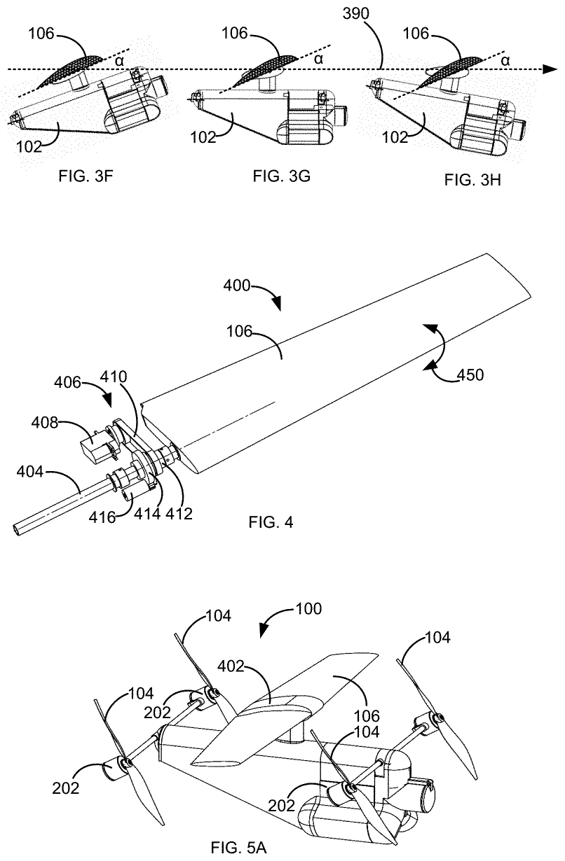

As shown in FIGS. 3A-3H, collectively referred to as FIG. 3, which are simplified diagram illustrations of the effect of orientation of rotor discs [symbol] on flight modes of a flight system in accordance with some embodiments of the invention. In FIG. 3A flight system 100 is in a state of hovering in which rotors 104 discs 302 are perpendicular to the force vector of gravity. The thrust vector, indicated in FIG. 3 by arrows designated reference number 350, is directed vertically upwards, in a direction opposite to the vector of gravity, indicating that all of the thrust generated by rotor discs 302 is allocated to countering the force of gravity and no thrust is directed forward i.e., a forward directed thrust vector (Ft) is zero (0).

In the exemplary embodiment depicted in FIG. 3B, rotor discs 302 are tilted to parallel the force vector of gravity. The thrust vectors 350 are directed horizontally forwards (towards nose 110 and parallel to longitudinal axis (X)) indicating that all of the thrust generated by rotor discs 302 is allocated to generate speed i.e., a forward directed thrust vector (Ft) is maximal. The flight mode depicted in FIG. 3B is a theoretical flight mode for purposes of clarity of explanation since in the absence of lift, generated by at least a component of the thrust vector directed vertically upwards to counter the force of gravity, flight system 100 cannot be maintained in the air.

FIG. 3C illustrates a compromise flight mode in which rotor discs 302 are tilted only partially forwards in which a vertical component (Lt) of the thrust generated by rotor discs 302 is aimed upwards maintaining a lift at the expense of the forward directed thrust vector (Ft′) component which is smaller (shorter), expressed by a slower speed.

Tilting rotor 104 discs 302 in respect to flight system 100 airframe 102 via one or more primary axles 214 and secondary axles 222 separately or concurrently effect direction and speed of movement of flight system 100 while maintaining the spatial orientation flight system 100 airframe 102 (and thus payload launcher 108) unchanged. A potential advantage of this configuration is in that a maintained spatial orientation of flight system 100 airframe 102 regardless of the direction of flight and/or the velocity of the flight system enables the system to aim the payload launcher 108 towards a target in any flight mode without the need to a turret or a gimbal mechanism.

FIGS. 3D and 3E, which are perspective view simplified illustrations of exemplary flight modes of flight system 100 rotor sub-system 200. FIG. 3D depicts a forward flight mode of flight system 100 in which secondary axles 222 have been rotated (pitched) about an axis perpendicular to longitudinal axis (X) of airframe 102, as indicated by arrow 325 to tilt or pitch rotors 104 discs at a partially forward-facing angle such that to provide forward as well as elevational thrust. In this flight mode, flight system 100 is driven forward in a direction indicated by arrow 375.

FIG. 3E depicts a sideways flight mode of flight system 100 in which primary axle 214 has been rotated (rolled) about an axis parallel to longitudinal axis (X) or longitudinal axis (X) itself of airframe 102 as indicated by arrow 355 and explained elsewhere herein to tilt or roll rotors 104 discs at a partially sideways-facing angle such that to provide sideways as well as elevational thrust. In this flight mode, flight system 100 is driven sideways in a direction indicated by arrow 395.

In both flight modes, depicted in FIGS. 3D and 3E, the spatial orientation of flight system 100 airframe 102, and thus payload launcher 108, has not changed in face of the change of tilt in rotor 104 discs. A potential advantage in a configuration such as that depicted for example, in FIG. 3E, in a situation in which flight system 100 payload launcher 108 is aimed at a target in face of a side wind, flight system 100 can maintain its position in reference to the ground surface, as well as the spatial orientation of airframe 102 and lunching system 108 by tilting rotors 104 discs into the wind.

FIGS. 3F-3H illustrate some embodiments showing the wing orientation under an effect of rotor sub-system 200 on an attitude of flight system in accordance with some embodiments of the invention. As shown in FIGS. 3F-3H, rotor sub-system 200 is configured to control and maintain flight system 100 at a forward, or any other direction, flight mode while controllably varying and maintaining the attitude of airframe 102 and therefore the aim of payload launcher 108.

In some embodiments, an attitude of flight system 100 airframe 102 is changed and maintained differential lift vectors generated by tilting variation e.g., between fore secondary axle 222-1 and aft secondary axle 222-2 and/or variable speed of rotation of one or more rotors rotor-driving mechanism (e.g., a motor) 202.

For example, the attitude of airframe 102 may vary in some embodiments, from a “nose-up” attitude (FIG. 3F), through a level attitude (FIG. 3G) to a “nose-down” attitude, while maintaining a constant level and direction of flight as indicated by an arrow 390. As shown in FIGS. 3F-3H, the angle of wing 106 is adjusted in respect to airframe 102 to maintain a constant angle of attack (a).

### The Wing Sub-System

As explained, in reference to FIG. 3, tilting rotor 104 discs 302 in respect to the force vector of gravity balances between generated forces of lift and forward thrust. This balance limits the airspeed of, as well as weight of the payload carried by, flight system 100. The greater the payload the more lift needed to be generated resulting in a slower airspeed. An addition of lift-generating airfoils to flight system 100 enables allocation of a greater portion of thrust generated by rotors 104 to forward movement and increased airspeed than without additional airfoils. In some embodiments, the airfoil comprises a wing 106.

Reference is now made to FIG. 4, which is a perspective view simplified illustration of a wing sub-system 400 of a flight system 100 comprising a fixed payload launcher in accordance with some embodiments of the invention. In some embodiments, flight system 100 comprises a wing 106 removably mounted to flight system 100 airframe 102 via a wing-mount 402 (FIG. 1A). A potential advantage in the addition of wing 106 is in that wing 106 is configured to generate lift during cruising which contributes to a decrease in energy consumption. A potential advantage in the addition of wing 106 is in that the wing enables allocation of a greater portion of thrust generated by rotors 104 to forward movement and thus increased airspeed.

In some embodiments, wing 106 comprises a wing shaft 404 which is pivotly coupled to wing-mount 402 e.g., via a ball bearing. In some embodiments, wing shaft crosses through wing-mount 402 and is coupled to a second wing 106 on an opposite side of wing-mount 402. For the purpose of clarity, all references to wing 106 apply to both wings 106 on both sides of wing-mount 402. In some embodiments, wing 106 is rigidly coupled to wing shaft 404 and rotatable bidirectionally about wing shaft 404 as indicated by a double headed arrow 450.

In some embodiments, wing system 400 comprises a wing angle adjusting mechanism 406. Wing angle adjusting mechanism 406 is accommodated within wing-mount 402 housing, which has been removed from FIG. 4 for the purpose of clarity and ease of explanation. As shown in FIG. 4, wing angle adjusting mechanism 406 comprises a driver 408 e.g., an electrical motor and a transmission 410. In some embodiments, transmission 410 comprises a belt. In some embodiments, transmission 410 comprises a gearbox.

As shown in FIG. 4, wing angle adjusting mechanism 406 comprises a clutch 412, mounted on wing shaft 404 and including a clutch disc 414 operated via a solenoid 416. Clutch 412 is configured to move from an engaged state (active mode of operation) in which power is transferred from transmission 410 to wing shaft 404, to a disengaged state (passive mode of operation) in which wing 104 is allowed to pivot freely about wing shaft 404. In some configurations, driver 408 and/or clutch 412 are controlled by an on-board and/or a remote processor via various means of communication. In some embodiments, shaft 404 is hollow. A potential advantage in hollow wing shaft 404 is in that wiring (electric and/or data) can be threaded through the lumen of the shaft eliminating weight of carrier wiring means and keeping loose and resilient wiring away from moving parts e.g., pivoting wing 104 thus increasing safety by reducing chances of malfunction and breakdown.

In some embodiments and as described in greater detail elsewhere herein, flight system 100 comprises one or more wing positioning and/or configuration:

a) A wingless flight mode (FIG. 1B);

b) Fixed-wing mode in which the angle of wing 106 is fixed in respect to flight system 100 airframe 102. In this configuration, the angle of attack of wing 104 is controlled by flight system 100 rotor sub-system 200. In this configuration, an attitude of airframe 102 can be predetermined as explained in greater detail elsewhere herein. In some embodiments, a fixed-wing mode can be set in situations, for example, of a breakdown in a wing-tilt mechanism;

c) An adjustable wing 106 angle of attack, in which clutch 412 is engaged and the angle of attack of wing 106 is adjusted by wing angle adjusting mechanism 406 controlled by an on-board and/or a remote processor via various means of communication; and

d) Neutral (passive) wing flight mode in which clutch 412 is disengaged and wing 104 is allowed to pivot freely about wing shaft 404.

Reference is now made to FIGS. 5A and 5B, which are perspective view simplified illustrations of one or more wing positioning and/or configuration associated with varying flight modes in accordance with some embodiments of the invention. In the exemplary embodiment depicted in FIG. 5A, flight system 100 is in a high-speed forward flight mode in which rotor 104 discs are tilted to provide a maximal forward thrust vector. In this flight mode, wing 106 is configured in an adjustable angle of attack mode in which clutch 412 is engaged and the angle of attack of wing 106 is controlled in real time by an on board processor and/or a remote processor.

A potential advantage of this configuration is in that wing 106 produces lift thus allowing tilting rotors 104 discs forwards and increase the forwards directed thrust vector at the expense of the lift generating vector of the thrust component as explained elsewhere herein. This allows winged flight system 100 (FIG. 1A) to fly faster than a wingless flight system 100 (FIG. 1B). A potential advantage of the configuration depicted in FIG. 5A is in that the angle of attack of wing 106 can be adjusted not only to allow a greater forward speed of flight, but also to be adjusted in association with the size of the payload e.g., launching system 108 deliverables, to be carried by flight system 100. In some embodiments, the angle of attack of wing 106 may be adjusted during flight or hovering by on board processor and/or a remote processor in correspondence with forward airspeed of flight system 100 and/or a changing payload weight e.g., by launching deliverables from payload launcher 108.

In the exemplary embodiment depicted in FIG. 5B, flight system 100 is in a hovering flight mode in which rotor 104 discs are maintained perpendicular to the vector of gravity to provide a maximal upwards thrust vector. In this flight mode, wing 106 is in a neutral (passive) wing flight mode in which clutch 412 is disengaged and wing 106 is allowed to pivot freely about wing shaft 404. As shown in FIG. 5B, wing 106 is drooped in respect to wing-mount 402. A potential advantage of this configuration is in that during hovering, wing 106 succumbs to aerodynamic disturbances such as e.g., wind gusts, maintaining the spatial orientation of flight system 100 and payload launcher 108.

In summary, several modes of flight of flight system 100 include at least:

a) A flight based on the lift of the aerodynamics surfaces. This mode is generally used for cruising or closing on a target. At this mode the frame's longitudinal axis is collinear with direction of flight as to minimize the drag, the wing is adjusted to produce the optimum lift and the rotors are tilted forward at an desired angle to supply the needed axial thrust (FIG. 5A). In this flight mode, part of the lift force is produced by the wing and the rest (vertical thrust vector) is produced by the rotors which also stabilize flight system 100 at desired spatial orientations.

b) Flight or hovering based only on the rotors. At this mode the wing 106 is at its neutral (passive) position about an axis of rotation (or totally annulled) as to minimize aerodynamics disturbance. The rotors are tilted on both axes as desired and the launcher (shown in FIG. 5B with an open cover) is aimed at a target.

A potential advantage in flight system 100 rotor sub-system 200 is in that airframe 102 can be designed to be aerodynamically longitudinally streamlined to reduce drag, energy requirements as well as allow for high-speed forward flying.

### The Load Launcher

In some embodiments, flight system 100 is configured to carry a payload. In some embodiments, the payload can be coupled to flight system 100 with an attachment mechanism such as, for example, a cargo hook. In some embodiments, flight system 100 comprises a payload launcher 108, configured for launching deliverables such as balls, nets, capsules, smoke grenades and any other suitable launchable deliverable.

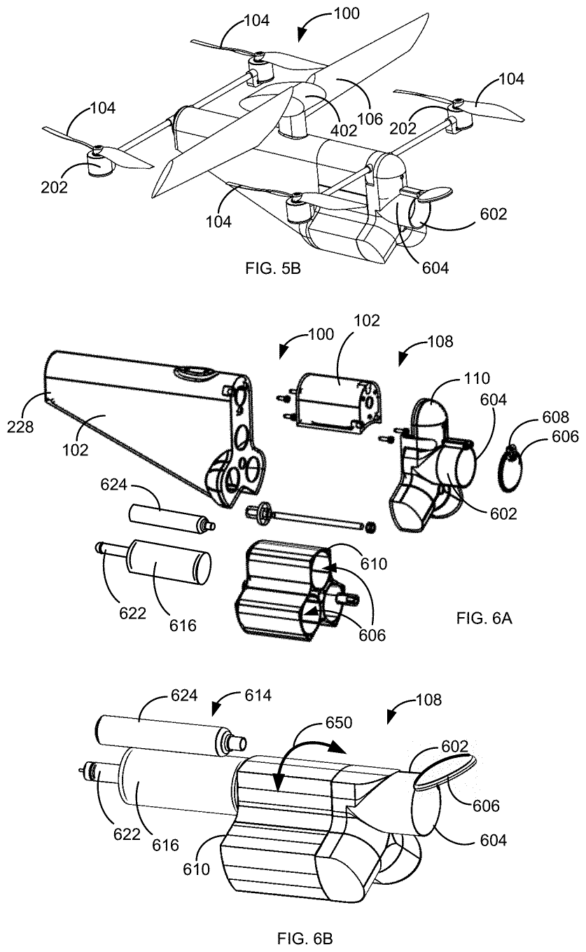

Referring now to FIGS. 6A and 6B, collectively referred to as FIG. 6, which are an exploded view, a perspective view and a cross section view simplified illustrations of a flight system 100 load launcher 108 in accordance with some embodiment of the invention. As shown in FIG. 6, payload launcher 108 comprises a launching tube 602, disposed along the longitudinal axis (X) of flight system 100. In some embodiments, payload launcher 108 is positioned such that the center of gravity of payload launcher 108 is congruent with the center of gravity of flight system 100.

In some embodiments, launching tube 602 opens at nose 110 of flight system 100 to a muzzle 604 covered by a cap 606. In some embodiments, cap 606 is pivotly coupled to launching tube 602 via a hinge 608 such that cap 606 is pivotable from an open, payload launching state (FIGS. 1A, 1B, 6B) to a closed state (FIGS. 3D, 3E and 5A). In some embodiments, hinge 608 comprises a mechanically or electrically activated opening mechanism. Alternatively, and optionally, in some embodiments, cap 606 is a “ball valve” mechanism that opens/closes muzzle 604 by rotating (e.g., by 90 degrees).

In some embodiments, the back end (facing flight system 100, tail 228) launching tube 602 opens to a magazine 610. In some embodiments, magazine 610 comprises one or more cells 612 each accommodating a launchable payload. In some embodiments, magazine 610 is a box magazine. In some embodiments, magazine 610 is a barrel/revolving magazine, which is rotatable (e.g., by a motor) in one or more directions, indicated in FIG. 6B by a double headed arrow 650, to place a “load” in line with launching tube 602.

In some embodiments, payload launcher 108 comprises an actuator 614 configured to drive and accelerate a payload through launching tube 602 and through muzzle 604. In some embodiments, actuator 614 comprises a fast release pneumatic actuator 614 configured to supply pressurized gas that drives and accelerates the payload through launching tube 602 and through muzzle 604. Pneumatic actuator 614 is aligned concentrically with a loaded cell 612 of magazine 610 and launching tube 602. In some embodiments, payload launcher 108 comprises any suitable pyrotechnic or non-pyrotechnic actuator 614.

In some embodiments, activation of the payload comprises activation of a launched payload comprising small particles (e.g. rice particles) and releasing a blast of air directly through the particles to carry them towards the target. In some embodiments, pneumatic actuator 614 comprises a source of pneumatic energy 624. Source of pneumatic energy 624 fluidly communicates with compressed air accumulator 616 and provides accumulator 616 with high pressure gas (compressed air or CO2) comprising the energy for each payload launch.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

In the description and claims of the application, each of the words “comprise” “include” and “have”, and forms thereof, are not necessarily limited to members in a list with which the words may be associated. In addition, where there are inconsistencies between this application and any document incorporated by reference, it is hereby intended that the present application controls.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A flight system comprising:
an airframe having a longitudinal axis; and
a rotor sub-system mounted on said airframe and comprising a plurality of rotors coupled to at least one secondary axle, said at least one secondary axle configured to:
(a) pivot and pitch in respect to said airframe about an axis perpendicular to said longitudinal axis of said airframe; and
(b) pivot and roll in respect to said airframe about an axis parallel to said longitudinal axis of said airframe,
while maintaining a spatial orientation of said airframe.

2. The flight system according to claim 1, wherein a pivot of said secondary axle changes a tilt angle of said rotors coupled thereto.

3. The flight system according to claim 1, comprising a primary axle pivotly coupled to said airframe and at least one of said secondary axles.

4. The flight system according to claim 1, comprising at least one motor disposed between said secondary axle and said rotor, wherein said at least one motor is configured to rotate said rotor.

5. The flight system according to claim 1, comprising one or more rotor-driving mechanisms disposed between said secondary axle and said rotors.

6. (canceled)

7. The flight system according to claim 2, comprising a fore-secondary axle and an aft-secondary axle and wherein a change in a tilt angle of rotors coupled to said fore-secondary axle in respect to a tilt angle of rotors coupled to said aft-secondary axle effects a change in an attitude of said airframe.

8. The flight system according to claim 1, wherein said rotor sub-system is configured to tilt and generate a thrust vector at any desired direction while maintaining spatial orientation of said airframe.

9. The flight system according to claim 1, wherein at least two of said rotors on a same secondary axle rotate in opposite directions.

10. (canceled)

11. (canceled)

12. (canceled)

13. The flight system according to claim 1, wherein said flight system comprises at least one airfoil mounted on said airframe and wherein said airfoil is a wing and said airframe comprises a wing mount coupled to said wing via a shaft and a wing angle adjusting mechanism.

14. (canceled)

15. The flight system according to claim 13, wherein said wing angle adjusting mechanism comprises a clutch configured to move from an engaged state to a disengaged state.

16. The flight system according to claim 15, wherein said flight system comprises an active mode of operation and a passive mode of operation,
wherein in said active mode of operation said wing angle adjusting mechanism is engaged and controls an angle of said wing in respect to said airframe, and
wherein in said passive mode of operation said wing angle adjusting mechanism is disengaged said wing is allowed to pivot freely about said wing shaft in respect to said airframe.

17. (canceled)

18. (canceled)

19. (canceled)

20. (canceled)

21. (canceled)

22. The flight system according to claim 1, wherein said flight system comprises a payload launcher fixedly coupled to said airframe, and wherein said payload launcher comprises a payload magazine.

23. The flight system according to claim 22, wherein a longitudinal axis of said payload launcher is parallel to a longitudinal axis of said airframe.

24. (canceled)

25. The flight system according to claim 23, wherein said payload magazine comprises a revolving magazine.

26. (canceled)

27. A flight system comprising:
an airframe having a longitudinal axis;
at least one airfoil mounted on said airframe and configured to generate lift and/or a moment during forward movement of said flight system; and
a rotor sub-system mounted on said airframe and comprising a plurality of rotors coupled to at least one secondary axle, said secondary axle configured to:
(a) pivot and pitch in respect to said airframe about an axis perpendicular to said longitudinal axis of said airframe; and
(b) pivot and roll in respect to said airframe about an axis parallel to said longitudinal axis of said airframe, while maintaining a spatial orientation of said airframe.

28. The flight system according to claim 27, wherein a pivot of said secondary axle changes a tilt angle of said rotors coupled thereto.

29. The flight system according to claim 27, comprising a primary axle pivotly coupled to said airframe and at least one of said secondary axles.

30. The flight system according to claim 27, wherein said flight system comprises a wing mount coupled to a wing via a shaft and a wing angle adjusting mechanism.

31. The flight system according to claim 30, wherein said wing angle adjusting mechanism comprises a clutch configured to move from an engaged state to a disengaged state.

32. (canceled)

33. A flight system kit comprising:
an airframe having a longitudinal axis;
at least one airfoil mountable on said airframe; and
a rotor sub-system mounted on said airframe and comprising
a plurality of rotors coupled to at least one secondary axle, said secondary axle configured to:
(a) pivot and pitch in respect to said airframe about an axis perpendicular to said longitudinal axis of said airframe; and
(b) pivot and roll in respect to said airframe about an axis parallel to said longitudinal axis of said airframe, while maintaining a spatial orientation of said airframe;
at least one rotor driving mechanism; and
an on-board processor and/or a remote processor.
